(19) United States
(12) Patent Application Publication
(10) Pub. No.: US 2010/0078844 A1
(43) Pub. Date: Apr. 1, 2010

(54) NON-LETHAL MUNITIONS HAVING DENSIFIED MATERIALS

(75) Inventor: John A. Kapeles, Casper, WY (US)

Correspondence Address: CHRISTIE, PARKER & HALE, LLP, PO BOX 7068, PASADENA, CA, 91109-7068, US

(73) Assignee: Defense Technology Corporation of America

(21) Appl. No.: 12/632,582

(22) Filed: Dec. 7, 2009

Related U.S. Application Data
(62) Division of application No. 11/454,347, filed on Jun. 16, 2006.

(51) Int. Cl. B29C 44/12

(52) U.S. Cl. 264/45.3; 264/271.1

(57) ABSTRACT

A non-lethal projectile having a nose component, a driving band adjacent the nose component and a body component wherein one or more of the projectile components comprises densified materials such as elastomers and foam that incorporate a dense filler material. The dense filler material is a heavy metal powder. The body component of the projectile includes a stabilizing component such as fins, drag stabilizing tails or streamers, or rifling bands for spin stabilization.

### BACKGROUND OF THE INVENTION

This invention relates to the field of non-lethal impact munitions, and more particularly, to munitions having densified materials used for portions of the projectile to provide a maximum amount of kinetic energy delivered by the munition, as well as providing a means to dissipate some of the energy through compression upon impact with a target.

Non-lethal munitions are commonly used by law enforcement, corrections, and military personnel to exert and maintain control over non-compliant subjects without inflicting serious or permanent bodily harm. They are used on individuals or in crowd control situations to provide law enforcement personnel with more alternatives for the “use of force” scale, which begins with verbal commands on the low end and escalates to the use of lethal force on the high end. To be effective, the less-than-lethal munition must inflict enough pain through blunt impact to illicit compliance, but the delivered energy to the subject must be controlled to prevent penetration or serious bodily injury. Accurate shot placement is critical to the effectiveness, because a non-lethal projectile can produce a serious or lethal injury if fired at certain areas of the human body, such as, for example, the head.

Previous non-lethal projectile designs exist which utilize various materials to increase projectile mass, and to provide some means to dissipate energy upon impact with a target. The kinetic energy is defined as one-half the mass times the square of the velocity, and these two quantities can be adjusted to increase or decrease the kinetic energy of the projectile, which affects the lethality characteristics. Impact munitions that deliver larger amounts of kinetic energy are far more effective for controlling subjects through pain compliance, but they also carry greater risk of serious injury to the subject. Maximizing the mass and velocity of the projectile significantly affects the range and accuracy of the round, which contributes to the safety of both the officer shooting the projectile and the target through more accurate shot placement at greater stand-off distances.

Clearly, it is desirable to increase the projectile mass and velocity for maximum effectiveness and accuracy, up to the point that serious injury would occur as a result of the kinetic energy delivered to the subject. To address this problem, previous projectile designs have incorporated features to dissipate energy upon impact with a target. Examples of these features include projectile noses made of compliant foam or rubber, or a nose material that crushes, breaks or deforms upon impact to dissipate energy. The compliant or deformable materials have inherently low density, which makes it difficult to maximize the projectile mass. In the case of fin or drag-stabilized projectiles, it is desirable to keep the center of gravity as far forward as possible, and the use of low-density nose materials makes this difficult. Other prior designs also incorporate noses filled with fluid materials such as lead shot, liquid or gel. These materials deform upon impact to provide greater surface area contact between the projectile and the target, and can provide some energy dissipation, especially if they rupture on impact. However, their fluid-like behavior can result in deformation when fired, causing interference as the projectile leaves the shell or exits the gas gun. Additionally, deformation prior to impacting the target can adversely affect the projectile stability in flight.

The most direct way to increase the projectile mass is to make the projectile out of a high-density material, such as a metal. However, there are significant drawbacks to the use of metals in these projectiles. In a non-lethal munition, fabricating the projectile out of metal would be unacceptable because of metal's inherent hardness and non-compliance. Further, use of a metal slug in a projectile takes up volume that could be used for a compliant nose material, and placement of the slug in the projectile body dictates the location of the center of gravity. Other options include using metal shot or powder, but these materials tend to deform like a fluid rather than deforming with dissipation of energy.

Historically, lead has been the material of choice used in all types of bullets and projectiles because of its density and ease of manufacturing. However, lead is recognized as a toxic substance to the human body, and as an environmental hazard with some degree of regulation on its disposal. For these reasons, ammunition manufacturers are beginning to replace lead with other substances that do not present these inherent problems. The replacement material must have adequate density properties, be available in sufficient quantities to be cost effective, and must not introduce any additional hazards for use, storage or disposal.

Thus there is a need for a less-than-lethal impact munition that will allow the projectile mass to be maximized while maintaining acceptable lethality properties. The projectile should incorporate compliant component materials that will dissipate energy upon impact with a target. The nose and body material density and compliance should be adjustable through formulation and processing changes to produce a projectile that will allow the weight, kinetic energy, center of gravity and lethality requirements to be met. The materials used in the projectile should not pose significant health or environmental concerns, and should be readily available at a cost suitable for high volume production.

### SUMMARY OF THE INVENTION

The present invention addresses the drawbacks and problems associated with prior non-lethal projectile designs and comprises a projectile used as a non-lethal impact munition when fired from a suitable delivery system such as a gas gun or shotgun. The projectile includes a nose section and a body section and is designed to deliver a prescribed amount of kinetic energy to a particular target. The projectile body includes features to provide aerodynamic stability during flight such as fins, tails or ribbons for drag stabilization, and/or rings on the body to engage rifling in the gun barrel to induce spin stabilization. The nose section of the projectile is made of an elastomeric material that has been formulated with a high-density powder, such as tungsten, to achieve increased projectile mass while maintaining the compliant or compressive qualities of the elastomer. The projectile design allows the maximum amount of kinetic energy to be delivered to the target as well as a means to dissipate some of that energy through compression of the elastomer upon impact with the target.

The new projectile design of the present invention comprises components made of densified materials such as elastomers and foams which incorporate a dense filler material. The elastomers include, but are not limited to, thermoplastic elastomers, such as polyurethanes; polyolefins, such as polyethylene or polypropylene; silicone rubber, such as room temperature vulcanizing silicon; polyvinyl chloride and polystyrene. Any variation of these elastomeric binders that are caused to foam by the introduction of heat, gas or by chemical reaction are contemplated, whether the resulting foam is flexible or rigid. The filler material can be any dense powder additive. The projectile body can include any structural flight body having stabilizing components such as fins, drag stabilizing tails or streamers, or rifling bands for spin stabilization. The contemplated launching system for these projectiles can be shotguns, such as a 12 gauge, or 37 or 40 mm gas guns. These launching systems are by way of illustration and are not meant to limit the physical size, caliber or projectile weight incorporating the novel aspects of the present invention.

The foregoing and other features of the present invention are hereinafter more fully described and particularly pointed out in the claims, wherein the following description setting forth in detail certain illustrative embodiments of the invention, being indicative, however of but a few of the various ways in which the principles of the invention may be employed.

### BRIEF DESCRIPTION OF THE DRAWINGS

FIG. 1 is a perspective view of a first embodiment of a non-lethal projectile of the present invention, typically used for a 12 gauge shotgun;

FIG. 2 is a perspective view of a second embodiment of a non-lethal projectile of the present invention;

FIG. 3 is a third embodiment of a non-lethal projectile of the present invention being a 40 mm projectile; and

FIG. 4 is a fourth embodiment non-lethal projectile of the present invention, also a 40 mm projectile.

### DETAILED DESCRIPTION OF THE DRAWINGS

FIG. 1 illustrates a non-lethal projectile 10 of the present invention, for example, for a 12 gauge shotgun having a molded projectile body 12 having a rifling band 14 for spin stabilization of the projectile and a densified foam or polymer nose section 16. The nose section, for example could be a tungsten powder filled polyurethane. The projectile body, for example, could be a densified base such as tungsten powder filled thermoplastic elastomer (TPE). The projectile body 12 is a cylindrical body and can also be molded or machined from polycarbonate and the rifling band 12 is slightly larger in diameter than the cylindrical body. The rifling band engages rifling in the barrel of a rifled-bore shotgun or launcher and impart spin to the projectile as it travels down the barrel.

To meet projectile weight, mass property, or stability requirements, the nose, rifling band or body components can be densified using density-enhanced polymer materials. This produces components with strength and mass properties similar to the metal filler material, but with hardness and compliance properties similar to the polymer materials. The components are fabricated by calculating the required amount of filler material to produce the desired density in the finished projectile. The polymer/filler material is then compounded prior to the molding operation to assure a homogenous mold material. An example of a suitable source of tungsten powder is a product named TECHNON, which is 99.9% pure tungsten metal powder and is sold by Tungsten Heavy Powders, Inc. of San Diego, Calif. The powder has a mean particle size in the 20-150 micron range. Other metal powders can be used as the filler material such as lead, iron or other heavy metals. The body is molded using conventional production molding techniques. The molded densified components of the present invention can be attached to each other using a suitable adhesive, such as cyanoacrylate, or the components can be molded in one piece using over-molding techniques. The dense powder additive can also be materials other than heavy metal, such as bismuth trioxide. The additive requires particulates denser than the elastomer material.

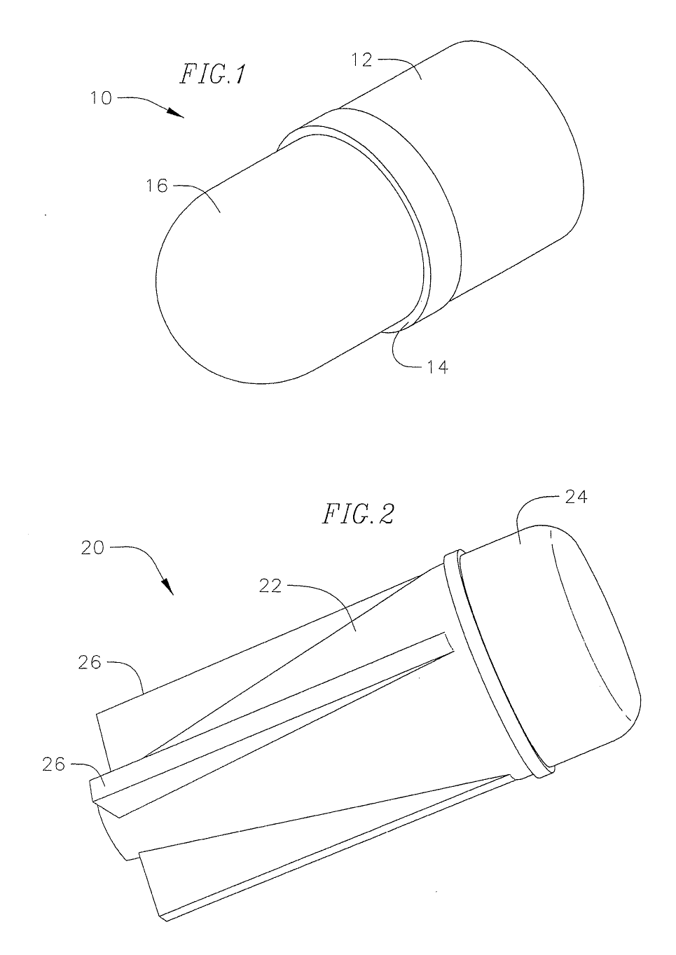

FIG. 2 illustrates a second embodiment projectile 20 having for example, a molded polyurethane finned body 22 and a densified foam nose 24. The finned body 22 has a number of fins 26 uniformly spaced around the circumference of the body. The densified foam nose 24 is produced by a process which has been developed to introduce a dense powder such a tungsten into the elastomer prior to the foaming step, so that after foaming, a much denser foam material is obtained. Due to the extremely high density of material such as tungsten, addition of a dense powder to an elastomeric foam has a dramatic effect on the material density and the resulting projectile mass. The projectile mass and delivered kinetic energy can be maximized without the use of solid metal slugs. The primary benefit of using an elastomeric foam as a projectile nose material is its compliant response when subjected to compression. This compliance allows energy dissipation upon impact with the target, minimizing the chance for serious injury. By controlling the amount of dense powder added to the elastomer prior to foaming, the compliant properties of the finished foam product can be maintained, along with the projectile lethality benefits. By using density-enhanced foam materials, the mass properties of the projectile can be adjusted without giving up desired material properties necessary for absorbing energy upon target impact.

A comparison of measured material properties for density-enhanced foam is illustrated in the following table which includes a comparison to a typical projectile foam nose material. The primary figure of merit that was used to compare the materials is a modified Indention Force Deflection (IFD, ASTM D3575) measurement, which is an industry standard for measuring the firmness of a foam sample by measuring the force required to compress the sample by 25%. The industry standard IFD measurement uses a sample that measures 15″ square by 4″ thick. Since this is not practical for measurement of a foam nose for a projectile, the test was modified to use a 1″×1″ cylindrical sample, and compared this measurement to IFD numbers for a material which was T600 olefin foam.

| | | | | In-house | ASTM |
|---|---|---|---|---|---|
| | | | | IFD | D3575 |
| | | Wt. % | Density | psi @ | psi @ |
| Sample | Description | Tungsten | (lb/ft 3) | 25% | 25% |
| 1 | Tungsten/PU foam | 94.84 | 241.9 | 144 | |
| 2 | Tungsten/PU foam | 93.72 | 189.9 | 55 | |
| 3 | Tungsten/PU foam | 92.90 | 117.0 | 22.5 | |
| 4 | PU Foam | 0.00 | 7.62 | 1.25 | |
| 5 | Minicel T600 | 0.00 | 6.84 | 17 | 18 |

As shown in sample 5, the in-house HD measurement yielded similar results to the ASTM test for the same material, giving some confidence to the measurement on the density-enhanced materials.

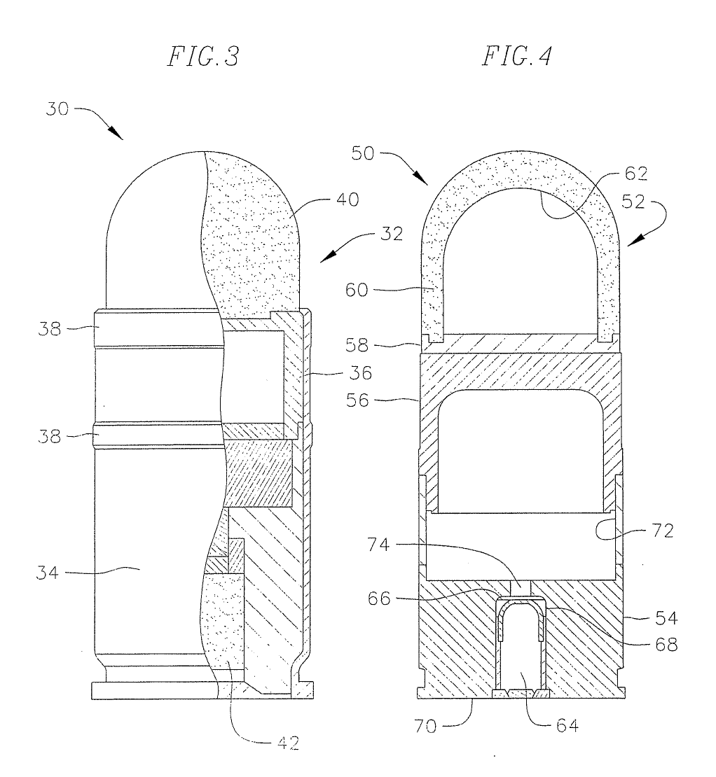

FIG. 3 illustrates a third embodiment munition 30 having a projectile 32 positioned within an aluminum 40 mm shell case 34 and comprising a molded polycarbonate body 36 having appropriate rifling bands 38 for spin stabilization and a densified foam nose 40. For example, the foam nose could be a tungsten-filled polyolefin and the projectile body 36 could be a tungsten-filled polycarbonate. The projectile is propelled from the casing by a smokeless powder charge 42 positioned in the casing below the projectile.

FIG. 4 illustrate a fourth embodiment non-lethal munition 50 having a projectile 52 positioned within a shell casing 54 having a molded polycarbonate base 56 a densified material mid-section 58 and a rigid, crushable densified foam nose 60. For example, the nose could be made of a tungsten filled polyurethane foam having a hollow section 62 so that the nose is crushable.

One example of a propulsion system for the present invention incorporates a blank cartridge 64 and a ruptured disc 66 positioned into a high pressure chamber 68 located at one end 70 of the shell casing. The high pressure chamber 68 is connected to a low pressure chamber 72 by a vent hole 74. The projectile 52 is positioned in the low pressure chamber 72 of the shell casing.

Although the present invention has been described and illustrated with respect to four embodiments thereof, it is not to be so limited since changes and modification can be made therein which is in the full intended scope of the invention as hereinafter claimed. For example, the projectile can be molded as a single piece having a nose component and a body component or can be molded as separate components and joined together.

1-16. (canceled)

17. A method of manufacturing a non-lethal projectile comprising the steps of:
selecting a desired elastomer material for the projectile;
calculating a required amount of filler material for a desired density of the projectile;
compounding the selected elastomer material and the calculated filler material; and
molding the compounded elastomer and filler materials into the projectile.

18. The method of claim 17 further comprising molding a nose component and a body component of the projectile.

19. The method of claim 18 further comprising the step of joining the nose component and the body component by an adhesive or by over molding.

20. The method of claim 18 wherein the step for molding the nose component is by foaming.

21. A method of manufacturing a non-lethal projectile comprising the steps of:
selecting a desired elastomer material for the projectile;
calculating a required amount of filler material for a desired density of the projectile;
then compounding the selected elastomer material and the calculated filler material prior to molding; and
molding the compounded elastomer and filler materials into the projectile.

22. The method of claim 21 further comprising molding a nose component and a body component of the projectile separately.

23. The method of claim 21 further comprising the step of joining the nose component and the body component by an adhesive or overmolding.

24. The method of claim 21 wherein the step of molding the nose component is by foaming.

25. A method of manufacturing a non-lethal projectile comprising the steps of:
selecting a desired elastomer material for the projectile;
calculating a required amount of filler material for a desired density of the projectile;
compounding the selected elastomer material and the calculated filler material; and
after compounding, molding the compounded elastomer and filler material into a projectile by foaming at least a portion of the projectile.
